(19) United States
(12) Patent Application Publication
(10) Pub. No.: US 2013/0222847 A1
(43) Pub. Date: Aug. 29, 2013

(54) SYSTEM THAT ENHANCES OPERABILITY AND CONVENIENCE WHEN USE OF SPECIFIC FUNCTIONS IS DESIRED, CONTROL METHOD THEREFOR AND IMAGE PROCESSING APPARATUS

(71) Applicant: Canon Kabushiki Kaisha, (US)

(72) Inventor: Keisui Okuma, Kawasaki-shi (JP)

(73) Assignee: CANON KABUSHIKI KAISHA, Tokyo (JP)

(21) Appl. No.: 13/773,746

(22) Filed: Feb. 22, 2013

(30) Foreign Application Priority Data
Feb. 24, 2012 (JP) 2012-038531

(51) Int. Cl. G06K 15/00

(52) U.S. Cl. CPC G06K 15/002
USPC 358/1.15

(57) ABSTRACT

A system having an image forming apparatus and at least one image processing apparatus that is capable of enhancing operability and convenience when use of specific functions is desired. The image forming apparatus comprises a holding unit that holds information on an image processing apparatus in a mode in which the first application can carry out a predetermined operation to the image forming apparatus. The image processing apparatus in which a first application and a second application are installed comprises a first obtaining unit that obtains information as to whether a process to a predetermined operation instruction is disabled, a second obtaining unit that obtains the information held by the holding unit of said image forming apparatus, and a control unit that determines whether the predetermined operation instruction is enabled based on the obtained information.

### BACKGROUND OF THE INVENTION

1. Field of the Invention

The present invention relates to a system, a control method therefor and an image processing apparatus.

2. Description of the Related Art

Some image forming apparatuses have a main body thereof equipped with only LEDs and operation keys without a display panel such as a liquid crystal panel. For such an image forming apparatus, a display of a host computer (hereafter referred to as a “host PC”) that operates the image forming apparatus is provided with a means for displaying a status of the image forming apparatus.

For example, there is known a method using a Web browser-based application that displays, on a Web browser operating on a host PC, information held in an image forming apparatus. According to this method, when HTML information generated by the image forming apparatus is sent to the host PC or the like, a status of the image forming apparatus is displayed on the Web browser operating on the host PC. A user can, for example, perform operations on the image forming apparatus (operations on a job being currently executed) through the Web browser.

There is known another method in which operations on an image forming apparatus are performed and function settings on an image forming apparatus are configured from a user interface (UI) application that operates on a host PC independently of a Web browser-based application. The UI application is a utility application that is installed in the host PC together with drivers for the image forming apparatus. Thus, by starting the UI application on the host PC, operations on an image forming apparatus are performed and function settings on an image forming apparatus can be configured through the UI application without requiring log-in operations.

Here, an image forming apparatus is provided with various functions, but some of the functions may be required to restrict users. Particularly, in recent years, a utilization form in which an image forming apparatus is shared by a plurality of users has been becoming widespread, and accordingly, there has been an increasing demand for establishing an environment in which conditions for use of an image forming apparatus can be managed on a user-by-user basis.

However, although the conventional Web browser-based application and UI application described above can perform operations on an image forming apparatus and configure function settings on the image forming apparatus, they do not set conditions for use of the image forming apparatus with respect to each administrator or user. For this reason, there has been proposed a method in which a server connected to an image forming apparatus manages conditions for use of the image forming apparatus with respect to each administrator or user (see Japanese Laid-Open Patent Publication (Kokai) No. H09-130532).

However, the method described in Japanese Laid-Open Patent Publication (Kokai) No. H09-130532 has a problem that an administrator of the image forming apparatus is required to, on a user-by-user basis, set conditions for permission to use the image forming apparatus with respect to specific functions offered by the image forming apparatus, and hence it takes a lot of time and effort to manage and use user accounts.

### SUMMARY OF THE INVENTION

The present invention provides a system that enhance operability and convenience when use of specific functions is desired, a control method therefor and an image processing apparatus.

Accordingly, a first aspect of the present invention provides a system, comprising an image forming apparatus, and at least one image processing apparatus configured to be connected to the image forming apparatus and in which a first application and a second application that can issue an operating instruction to the image forming apparatus are installed, wherein the image forming apparatus comprises a holding unit that holds information on an image processing apparatus which has been shifted to a mode in which the first application can carry out a predetermined operation to the image forming apparatus among the at least one image processing apparatus while the image processing apparatus is shifted to the mode, and wherein the at least one image processing apparatus comprises a first obtaining unit that obtains information as to whether a process corresponding to a predetermined operation instruction is disabled in the image forming apparatus, a second obtaining unit that obtains, in a case where the first obtaining unit obtains the information indicative of execution of the process corresponding to the predetermined operation instruction being disabled when the second application issues the predetermined operation instruction to the image forming apparatus, the information on the image processing apparatus which is held by the holding unit of the image forming apparatus, and a control unit that determines whether the predetermined operation instruction to the image forming apparatus by the second application is enabled based on the information obtained by the second obtaining unit.

Accordingly, a second aspect of the present invention provides a control method for a system comprising an image forming apparatus and at least one image processing apparatus configured to be connected to the image forming apparatus and in which a first application and a second application that can issue an operating instruction to the image forming apparatus are installed, the method comprising a holding step of holding in the image forming apparatus information on an image processing apparatus which has been shifted to a mode in which the first application can carry out a predetermined operation to the image forming apparatus among the at least one image processing apparatus while the image processing apparatus is shifted to the mode, and a first obtaining step of obtaining information as to whether a process corresponding to a predetermined operation instruction by the second application is disabled in the image forming apparatus, a second obtaining step of, in a case where the information indicative of execution of the process corresponding to the predetermined operation instruction being disabled is obtained in the first obtaining step when the second application issues the predetermined operation instruction to the image forming apparatus, obtaining the information held in the image forming apparatus in the holding step, and a control step of determining whether the predetermined operation instruction to the image forming apparatus by the second application is enabled based on the information obtained in the second obtaining step.

Accordingly, a third aspect of the present invention provides an image processing apparatus that is connected to an image forming apparatus and in which a first application and a second application that can issue an operating instruction to the image forming apparatus are installed, comprising an obtaining unit configured to obtain from the image forming apparatus information as to whether a process corresponding to a predetermined operation instruction is disabled in the image forming apparatus, and a control unit configured to, in a case where the obtaining unit has been obtained the information indicating that the process corresponding to the predetermined operation instruction is disabled, enables the predetermined operation instruction to the image forming apparatus by the second application when the first application is in a mode in which the first application can carry out a predetermined operation to the image forming apparatus, and disables the predetermined operation instruction to the image forming apparatus by the second application when the first application is not in the mode.

According to the present invention, operability and convenience can be enhanced when use of specific functions offered by the image forming apparatus is desired, such as functions requiring authorization and functions for which usage is limited, is desired.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of an operation system for an image forming apparatus according to a first embodiment of the present invention.

FIG. 2 is a block diagram schematically showing a hardware arrangement of a host PC appearing in FIG. 1.

FIG. 3 is a block diagram schematically showing a hardware arrangement of a printer appearing in FIG. 1.

FIG. 4 is a diagram schematically showing how the host PC and the printer appearing in FIG. 1 communicate information with each other.

FIGS. 5A and 5B are views showing exemplary UI screens of a RUI operating on the host PC appearing in FIG. 1.

FIG. 6 is a view showing an exemplary UI screen of a status window operating on the host PC appearing in FIG. 1.

FIG. 7 is a diagram showing exemplary user information and setting information held by the printer appearing in FIG. 1.

FIG. 8 is a schematic diagram showing a series of processes carried out in the operation system appearing in FIG. 1.

FIG. 9 is a flowchart showing the procedure of a process carried out by the RUI operating on the host PC appearing in FIG. 1.

FIG. 10 is a first flowchart showing the procedure of a process carried out by the status window operating on the host PC appearing in FIG. 1.

FIG. 11 is a second flowchart showing the procedure of a process carried out by the status window operating on the host PC appearing in FIG. 1.

FIG. 12 is a flowchart of an administrator authentication process carried out by the printer appearing in FIG. 1.

FIG. 13 is a flowchart of a job operation process carried out by the printer appearing in FIG. 1 in response to a job operation request.

FIG. 14 is a flowchart showing a variation of a process carried out by the status window operating on the host PC appearing in FIG. 1.

FIG. 15 is a flowchart showing a variation of a process carried out by the printer appearing in FIG. 1.

### DESCRIPTION OF THE EMBODIMENTS

The present invention will now be described with reference to the drawings showing embodiments thereof.

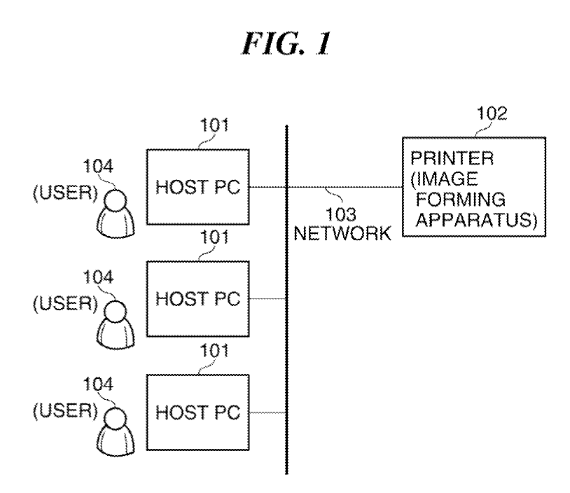

FIG. 1 is a diagram schematically showing an arrangement of an operation system for an image forming apparatus according to a first embodiment of the present invention (hereafter referred to as “the operation system”). The operation system in FIG. 1 is also applied to a second embodiment and a third embodiment, to be described later.

The operation system in FIG. 1 is comprised of a plurality of host PCs 101 (image processing apparatus), which are operated by users, and a printer 102 that is an image forming apparatus connected to the host PCs 101 via a network 103 such as a LAN. It should be noted that the printer 102 encompasses not only image forming apparatus having only printing functions but also image forming apparatuses such as multi-function peripherals (MFP).

A remote user interface (hereafter referred to as a “RUI”) that is a Web browser (first application), which is a Web-based application capable of giving operating instructions to the printer 102, is installed and available in each host PC 101. Also, a status window, which is a UI application (second application) capable of issuing operational instructions to the printer 102, is installed and available in each host PC 101. The RUI and the status window are independent applications, and they need to be launched individually.

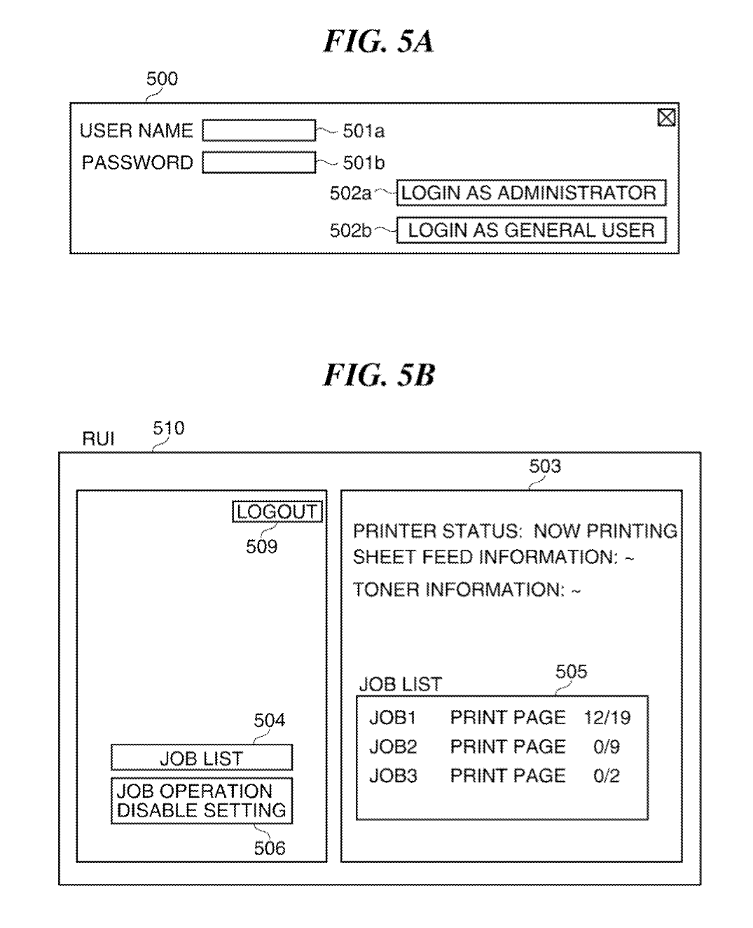

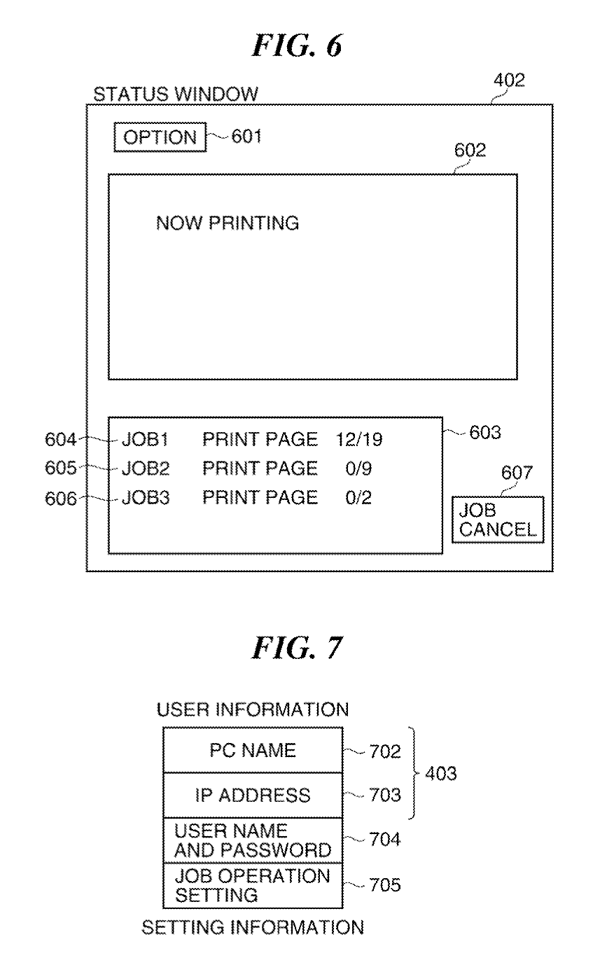

It should be noted that an exemplary UI screen of the RUI will be described later with reference to FIG. 5. Also, an exemplary UI screen of the status window will be described later with reference to FIG. 6. A user 104 can issue operating instructions to the printer 102 and configure settings on the printer 102 through these applications operating on the host PC 101.

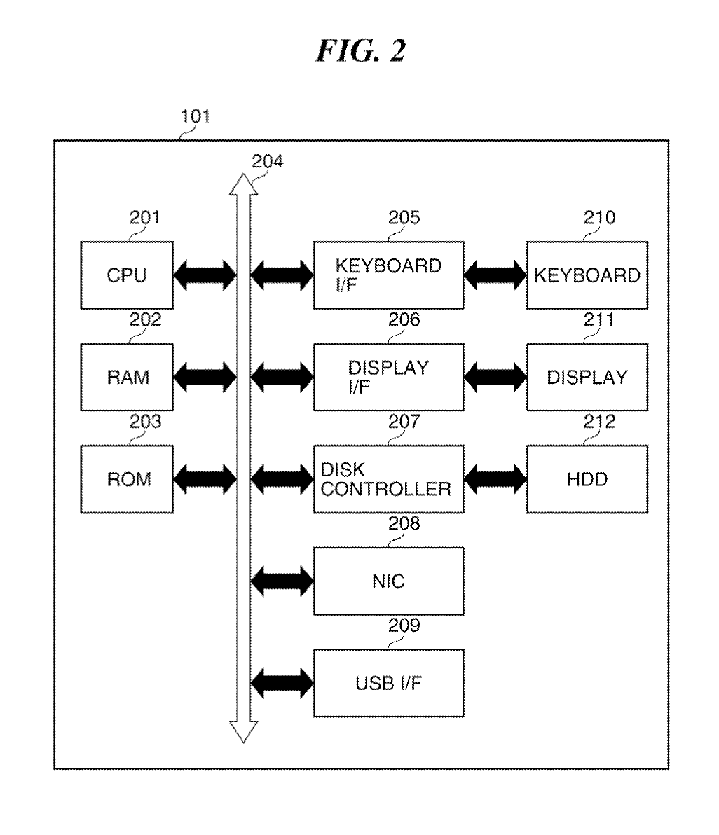

FIG. 2 is a block diagram schematically showing a hardware arrangement of the host PC 101 appearing in FIG. 1. The host PC 101 has a CPU 201 that executes software (programs) stored in a ROM 203 or an HDD 212, and the CPU 201 is responsible for controlling the entire host PC 101. A RAM 202 acts as a main memory, a work area, and so on.

A keyboard I/F 205 controls key input from a keyboard 210. A display I/F 206 controls a display 211. A disk controller 207 controls access to the HDD 212. A network interface card (NIC) 208 carries out two-way communications with other equipment. A USB I/F 209 allows connection with a USB device. These devices are placed on a system bus 204.

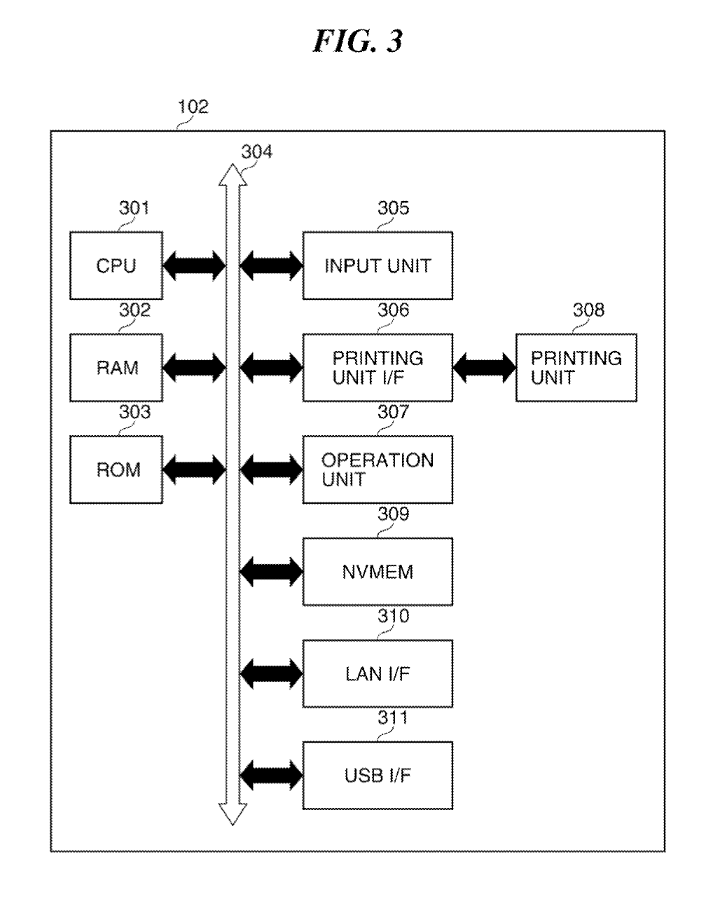

FIG. 3 is a block diagram schematically showing a hardware arrangement of the printer 102 appearing in FIG. 1. A RAM 302 is a system work memory for operation of a CPU 301 and is also a memory for temporarily storing image data or the like. Programs for controlling the printer 102, information available on the host PC 101, and so on are stored in a ROM 303. The CPU 301, which controls the entire printer 102, is capable of communicating with the host PC 101 via an input unit 305 and notifying the host PC 101 of information in the printer 102 or the like.

Image data to be printed sent from the host PC 101 is output to a printing unit 308 via a printing unit I/F 306. An operation unit 307 has switches, LED display, and so on for operation on an operation panel. An NVMEM 309, which is a nonvolatile memory, in which setting information such as a password, to be described later, is stored. A LAN I/F 310 allows LAN connection with the host PC 101. A USB I/F 311 allows USB connection with the host PC 101. These devices are placed on a system bus 304.

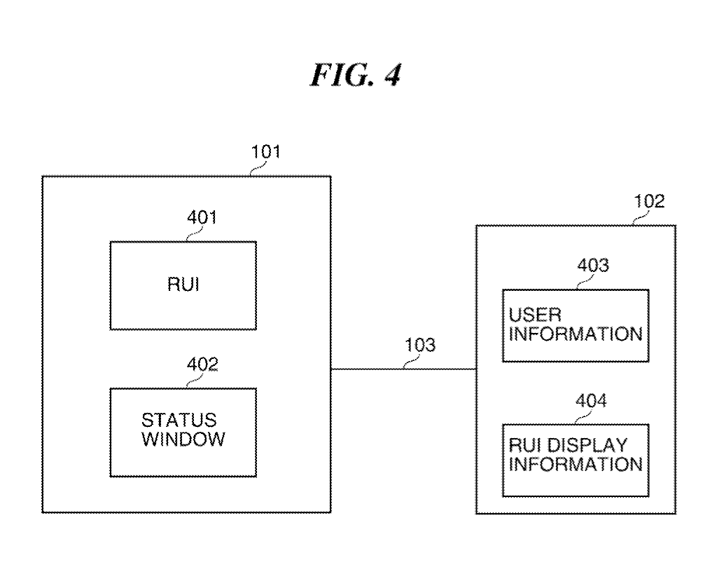

FIG. 4 is a diagram schematically showing how the host PC 101 and the printer 102 communicate information with each other. On the host PC 101, a RUI 401 and a status window 402, which are applications capable of giving operating instructions to the printer 102, are started independently of each other. Functions of the RUI 401 and the status window 402 are realized by the CPU 201 executing predetermined programs stored in the HDD 212.

The RUI 401 has a function of enabling a user to log in as an administrator by inputting a user name and a password. This function will be described later in detail with reference to FIG. 5. A user name and a password input on the RUI 401 are sent to the printer 102 via the network 103. The CPU 301 of the printer 102 collates the received user name and password with a user name and a password stored as setting information on the NVMEM 309 and notifies the RUI 401, which is operating on the host PC 101, of the collation result.

As will be described later in detail with reference to FIG. 6, the status window 402 displays a job list 603 of jobs to be executed by the printer 102 to allow operations on the jobs.

User information 403, to be described later with reference to FIG. 7, is stored in the NVMEM 309 of the printer 102. RUI display information 404 is information to be displayed on the RUI 401 operating on the host PC 101. The RUI display information 404 is sent to the RUI 401 operating on the host PC 101, and as a result, a UI screen as shown in FIG. 5B, to be described later, is displayed.

FIGS. 5A and 5B are views showing exemplary UI screens of the RUI 401 operating on the host PC 101. FIG. 5A shows a login screen 500, which is a screen appearing first when the RUI 401 is launched on the host PC 101. Operations on the screens are performed using the keyboard 210 of the host PC 101 and an operation member such as a mouse.

When the user 104 inputs a user name and a password in a user name input field 501a and a password input field 501b, respectively, on the login screen 500 and depresses an administrator login button 502a, the input user name and password are sent to the printer 102. In the printer 102, the received user name and password are collated with a user name and a password included in setting information stored in the NVMEM 309 to determine whether or not the user 104 matches an administrator, and when it is determined that the user 104 matches an administrator, he or she is permitted to log in as an administrator. In this way, the RUI 401 shifts into an administrator mode.

On the other hand, to log in as a general user other than an administrator, the user 104 should depress a general user login button 502b without inputting a user name and a password, and as a result, he or she is permitted to log in as a general user. In this way, the RUI 401 shifts into a general user mode.

It should be noted that whether the user 104 logs in as either an administrator or a general user via login screen 500, the RUI 401 sends a PC name and an IP address of the host PC 101 on which the RUI 401 is launched. The printer 102 holds the received PC name and IP address as user information 403 in the NVMEM 309 until the printer 102 receives a logout signal from the host PC 101.

Because the RUI 401 is a Web browser-based application as described earlier, it receives HTML data or the like created by the printer 102 and displays a status of the printer 102 on a Web browser.

FIG. 5B shows an exemplary administrator mode screen (administrator browser screen) 510 of the RUI 401 displayed on the host PC 101 when the user 104 has successfully logged in as an administrator via the login screen 500 in FIG. 5A. When a logout button 509 of the administrator mode screen 510 is depressed, the administrator mode screen 510 is closed.

In a status display field 503, a current status of the printer 102, sheet feed information, toner information, and so on are displayed. When a job list button 504 is depressed, a current job list 505 for the printer 102 is displayed in the status display field 503. By selecting a job displayed in the current job list 505, the user 104 who has logged in as an administrator can request the printer 102 to perform a predetermined operation such as cancellation. For example, when a job is selected, a transition to a screen on which more detailed information on the selected job (the number of pages, time of job input, user name, and so on) is displayed takes place, and on this screen, the job can be cancelled, for example.

In the present embodiment, a job operation disable setting button 506 is displayed on only the administrator mode screen 510, and a user who has logged in an administrator (that is, a user who is authorized as an administrator) can depress the job operation disable setting button 506. Namely, in the present embodiment, as a specific operation that cannot be performed in the general user mode, a setting to disable job operation on the printer 102 can be made in the administrator mode. When the job operation disable setting button 506 is depressed, this command is sent to the printer 102, and the CPU 301 of the printer 102 sets a job operation disable flag in the NVMEM 309.

When job operations are disabled, for example, characters and a background in the job operation disable setting button 506 are reversed (characters are outlined on a colored background) to make the user who has logged in as an administrator recognize that job operations are disabled. On the other hand, when job operations are not disabled, for example, a background in the job operation disable setting button 506 is turned into colorless to make the user who has logged in as an administrator recognize that job operations are not disabled.

It should be noted that on a general user mode screen (not shown) displayed when the user 104 logs in as a general user, the “job operation disable setting button 506” is not displayed. Namely, in the present embodiment, a difference between the administrator mode screen 510 and the general user mode screen is in whether or not the “job operation disable setting button 506” is displayed. Thus, a user who has logged in as a general user is not authorized to disable job operations in the printer 102.

FIG. 6 is a view showing an exemplary UI screen of the status window 402 operating on the host PC 101. The status window 402, which is an application operating independently on the host PC 101, can be launched irrespective of whether or not a user is an administrator.

The UI screen of the status window 402 is displayed based on information such as commands sent and received to and from the printer 102 by the status window 402. A current status of the printer 102 is displayed in a status display field 602. A list of print jobs sent to the printer 102 (in the present embodiment, a job 1 604, a job 2 605, and a job 3 606), the number of print pages, and so on are displayed in the job list 603.

When the job operation disable setting on the RUI 401 is not enabled, the user can cancel a desired one of the jobs 604 to 606, which are displayed in the job list 603, by depressing a job cancel button 607. Even when the job operation disable setting on the RUI 401 is enabled, the user can cancel execution of a desired job by depressing the job cancel button 607 of the status window 402 as long as predetermined conditions are satisfied. The “predetermined conditions” will be described later in detail with reference to FIG. 10.

It should be noted that there may be cases where, when execution of job cancellation from the status window 402 is disabled, the user would like to cancel a job by logging in on the RUI 401 as an administrator. In this case, by depressing an option button 601 of the status window 402, the login screen 500 of the RUI 401 is opened.

FIG. 7 is a diagram showing exemplary user information 403 and setting information, which are authentication information held by the printer 102. A PC name 702 included in the user information 403 represents a name of the host PC 101, and an IP address 703 included in the user information 403 represents an address assigned to the host PC 101. They are identification information on the host PC 101. The PC name 702 and the IP address 703 are held based on information sent from the RUI 401 when a user logs in from the login screen 500 of the RUI 401 irrespective of whether the user logs in as an administrator or a general user.

A user name and password 704 included in the setting information is identification information on the user, which is held in advance in the printer 102 and used for authentication when the user logs in as an administrator from the login screen 500. A job operation setting 705 is information indicative of whether it is possible to perform operations on jobs in the printer 102, and for example, information indicative of “job operations enabled” and “job operations disabled” is held.

When “job operations enabled” is set, the user can perform job operations such as a job cancellation from either the RUI 401 or the status window 402. In the present embodiment, even when “job operations disabled” is set, the user can perform job operations from the RUI 401 as long as he or she has successfully logged in as an administrator from the RUI 401.

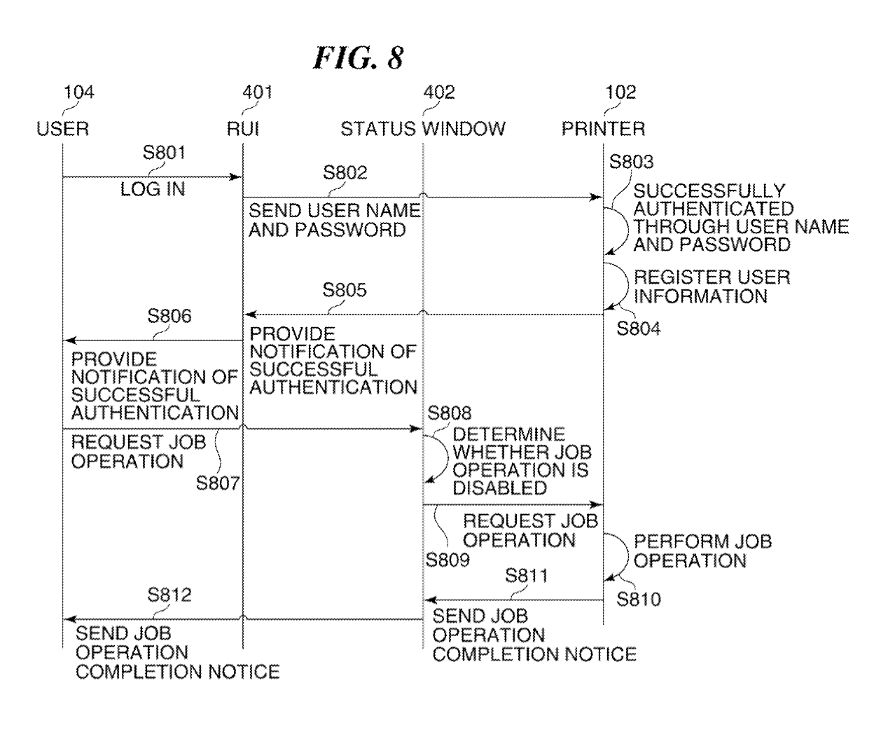

FIG. 8 is a schematic diagram showing a series of processes carried out in the operation system. The user 104 activates the RUI 401 on a predetermined host PC 101, inputs a user name and a password on the login screen 500, and logs in as an administrator (step S801). The RUI 401 sends the input user name and password as well as a PC name and an IP address of the host PC 101 to the printer 102 (step S802).

The CPU 301 of the printer 102 performs authentication by collating the received user name and password with a user name and a password held as setting information (step S803). When authentication is successful, the CPU 301 of the printer 102 holds, as the user information 403, the PC name and the IP address of the host PC 101 on which the RUI 401 that has sent the user name and the password is operating (step S804). Then, the CPU 301 of the printer 102 notifies the RUI 401 that the user 104 has successfully logged in as an administrator (step S805). In response to the notification in the step S805, the RUI 401 displays the administrator mode screen 510 (step S806).

The user 104 starts the status window 402 and requests a job operation via the status window 402 (step S807). In the present embodiment, a “job operation” corresponds to selecting a predetermined job and then depressing the job cancel button 607.

According to predetermined conditions, the status window 402 determines whether or not job operations are disabled (step S808). The “predetermined conditions” will be described later with reference to FIG. 10.

When job operations are not disabled, the status window 402 requests the printer 102 to perform the job operation (step S809), and in response to the job operation request, the printer 102 performs the job operation as requested (step S810). Thereafter, the printer 102 provides the status window 402 with notification of completion in response to the job operation request (step S811). The UI screen of the status window 402 is updated in accordance with the received notice of completion to notify the user that the job operation has been performed (step S812).

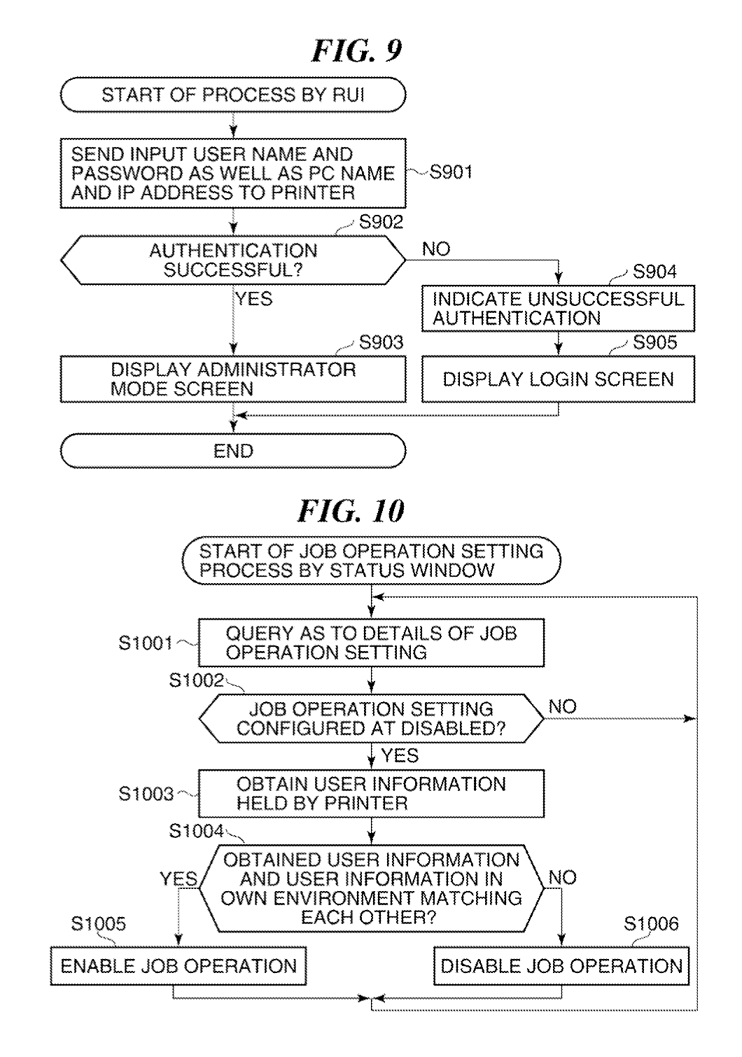

FIG. 9 is a flowchart showing the procedure of a process carried out by the RUI 401 operating on the host PC 101. The RUI 401 sends a user name and a password, which has been input by the user 104 via the login screen 500 so as to log in as an administrator, as well as a PC name and an IP address of the host PC 101 to the printer 102 (step S901).

Then, the RUI 401 receives a result of authentication by the printer 102 and determines whether or not authentication is successful (step S902). Specifically, in the step S902, the RUI 401 determines whether or not to permit shifting into the administrator mode in which an instruction to perform a specific operation is allowed to be issued to the printer 102.

When authentication is successful (YES in the step S902), the RUI 401 shifts into the administrator mode to display the administrator mode screen 510 (step S903) and terminates the process. On the other hand, authentication is not successful (NO in the step S902), the RUI 401 displays a message saying that authentication is not successful (for example, “incorrect user name or password”) (step S904) and returns control to the login screen 500 (step S905). As a result, the RUI 401 prompts the user to input a user name and a password again on the login screen 500 and log in as an administrator.

FIG. 10 is a first flowchart showing the procedure of a process carried out by the status window 402 and mainly shows how the “predetermined conditions” used in the step S808 in FIG. 8 are determined. The process in FIG. 10 is a process that is carried out irrespective of which one among the plurality of host PCs 101 appearing in FIG. 1 starts the status window 402, and is not limited to a process that is carried out by the host PC 101 on which the RUI 401 is launched before the step S807 in FIG. 8.

When launched on a predetermined host PC 101, the status window 402 queries the printer 102 as to details of the job operation setting 705 included in setting information held by the printer 102 and obtains a response to this (step S1001). Specifically, in the step S1001, the status window 402 acts as a first obtaining unit to query the printer 102 as to whether or not the job operation disable flag is set and obtain a response to this.

The status window 402 determines whether or not the job operation setting 705 is configured at “disabled” (whether or not the job operation disable flag is set) (step S1002). When the job operation setting 705 is not configured at “disabled” (NO in the step S1002), the status window 402 returns to the step S1001. Namely, the status window 402 monitors the job operation setting 705 included in the setting information held by the printer 102. Thus, an environmental change can be dealt with when a job operation disable setting is made from the RUI 401 launched on another host PC 101.

When the job operation setting 705 is configured at “disabled” (YES in the step S1002), the status window 402 acts as a second obtaining unit to obtain user information held by the printer 102 (step S1003). The user information obtained by the status window 402 in the step S1003 is comprised of a PC name and an IP address held as the PC name 702 and the IP address 703 which are elements of the user information 403.

Then, the status window 402 determines whether or not the user information obtained in the step S1003 (the PC name and the IP address) matches an environment of the host PC 101 on which the status window 402 is operating (step S1004). Namely, the status window 402 determines whether or not the user information obtained in the step S1003 is indicative of the host PC 101 on which the status window 402 is operating.

When the status window 402 determines that the user information obtained in the step S1003 matches the environment of the host PC 101 (YES in the step S1004), the status window 402 enables job operations from the status window 402 (step S1005). On the other hand, when the status window 402 determines that the user information obtained in the step S1003 does not match the environment of the host PC 101 (NO in the step S1004), the status window 402 disables job operations from the status window 402 (step S1006).

Concrete examples of the case where job operations are enabled include a case where a user starts the status window 402 on the host PC 101 in which the user has logged in as an administrator via the RUI 401. On the other hand, examples of the case where job operations are disabled include a case where the user information 403 in the printer 102 is null when the status window 402 obtains the user information 403 from the printer 102. Namely, examples of the case where job operation is disabled include a case where, even when the status window 402 is launched on the host PC 101 on which the RUI 401 has been launched, a user has already logged out of the RUI 401 when the status window 402 is launched. Examples of the case where job operations are disabled include another case where the status window 402 is launched on the host PC different from the host PC 101 on which the RUI 401 has been launched.

After carrying out the processes in the steps S1005 and S1006, the status window 402 returns to the step S1001.

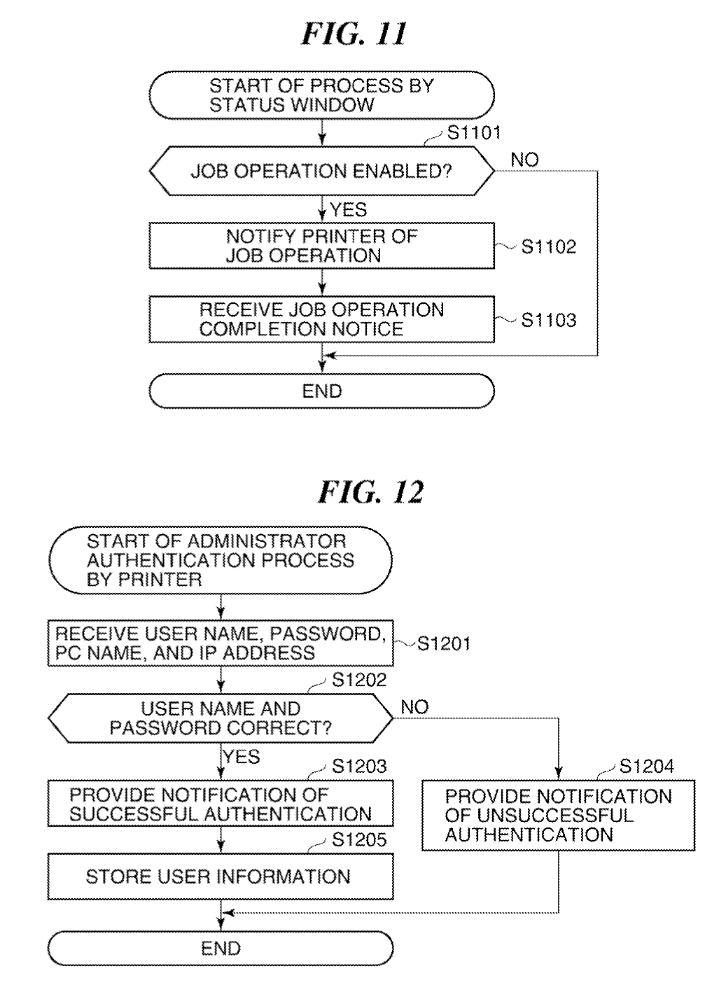

FIG. 11 is a second flowchart showing the procedure of a process carried out by the status window 402 and mainly shows details of the processes carried out in the steps S809 to S812.

Upon receiving a job operation from the user, the status window 402 determines whether or not job operations from the status window 402 are enabled according to whether or not the process has proceeded to the step S1005 or the step S1006 (step S1101).

When job operations from the status window 402 are not enabled (NO in the step S1101), no job operation can be accepted even when a job operation is requested (even when the job cancel button 607 is depressed). For example, the status window 402 makes the job cancel button 607 provide an indication of being disabled or displays a message saying, for example, that “job cancellation is disabled”, thus making the user recognize that no job operation can be accepted.

When job operations from the status window 402 are enabled (YES in the step S1101), the status window 402 notifies the printer 102 of the job operation (step S1102). Upon completing a process for the received job operation, the printer 102 sends a job operation completion notice to the status window 402 (see the step S811), and hence the status window 402 receives the job operation completion notice (step S1103). As a result, the UI screen of the status window 402 is updated so that the user can know that the job operation he or she had requested has been accepted and processed.

FIG. 12 is a flowchart of an administrator authentication process carried out by the printer 102 and shows details of the processes carried out in the steps S803 to S805 in FIG. 8. The CPU 301 of the printer 102 receives, from the RUI 401, a user name and a password input on the login screen 500, and a PC name and an IP address of the host PC 101 (step S1201).

The CPU 301 performs authentication for the user 104, that is, determines whether or not the received user name and password are present in the stored user name and password 704 (step S1202). When authentication is successful, the CPU 301 notifies the RUI 401 that authentication is successful (step S1203) and holds, in the user information 403, the PC name and the IP address received in the step S1201 (step S1205). Namely, in the step S1205, the PC name and the IP address of the host PC 101 that has shifted into the administrator mode are held in the printer 102.

It should be noted that when the host PC 101 has logged out of the administrator mode, the PC name and the IP address held in the printer 102 are deleted. Namely, the printer 102 holds the PC name and the IP address of the host PC 101 only while the RUI 401 is held in the administrator mode.

When authentication is not successful (NO in the step S1202), the CPU 301 notifies the RUI 401 that authentication is not successful (step S1204). The user information 403 held in the step S1205 is used in the steps S1003 and S1004 of the flowchart in FIG. 10 described earlier.

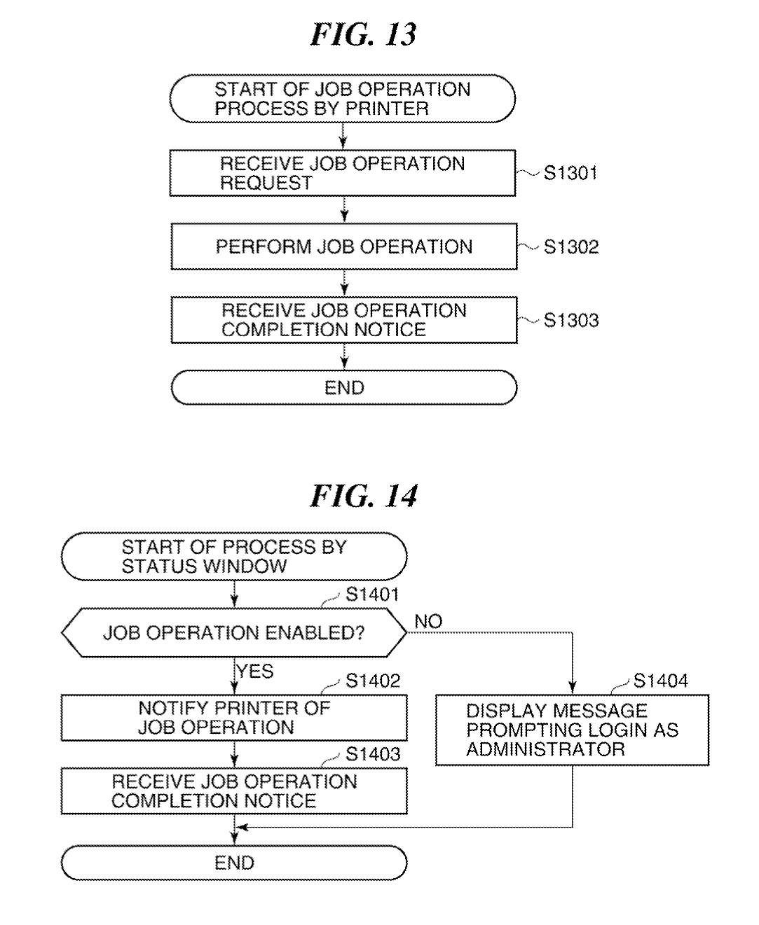

FIG. 13 is a flowchart of a job operation process carried out by the printer 102 and shows details of the processes carried out in the steps S810 to S811 in FIG. 8. The CPU 301 of the printer 102 receives a job operation request (job cancel) from the status window 402 (step S1301). The CPU 301 performs a job operation in accordance with the received job operation request (step S1302) and notifies the status window 402 that the job operation has been completed (completion notice) (step S1303).

Because the usability of the status window 402 is higher than that of the RUI 401, users would like to operate the printer 102 from the status window 402 in many cases. Conventionally, however, if the user 104 who has logged in on the RUI 401 as an administrator disables job operations on the printer 102, even an administrator cannot operate the printer 102 from the status window 402. This is because the status window 402 cannot discriminate between an administrator and general users other than the administrator.

On the other hand, in the operation system according to the first embodiment, even when the job operation setting 705 is configured at “disabled” in the printer 102, the user 104 can perform operations from the status window 402 as long as he or she has logged in on the RUI 401 as an administrator. Namely, the user 104 is allowed to perform operations, for which authority is required, on the printer 102 without the need to provide the status window 402 with a function of authenticating the user 104 as an administrator.

In the first embodiment, in the state where the job operation setting 705 is configured at “disabled”, the user 104 cannot request a job operation from the status window 402 unless he or she has logged in on the RUI 401 as an administrator. Accordingly, in the second embodiment, when job operations are disabled on the status window 402, a message prompting a user to log in on the RUI 401 as an administrator is displayed.

FIG. 14 is a flowchart showing a variation of a process carried out by the status window 402. The status window 402 determines whether or not job operations are enabled (step S1401). When job operations are enabled (YES in the step S1401), the status window 402 notifies the printer 102 of a job operation request (step S1402) and thereafter, receives a job operation completion notice from the printer 102 (step S1403).

When job operations are not enabled (NO in the step S1401), the status window 402 displays on the UI screen thereof a message prompting a user to log in on the RUI 401 as an administrator (step S1404). Because as a result of the process in FIG. 10, the status window 402 detects that the user information 403 held in the printer 102 has been rewritten, execution of the job operation request is enabled when the user logs in as an administrator from the RUI 401.

In a third embodiment described hereafter, usage conditions of the printer 102 are managed on a division-by-division basis. Examples of a method to manage usage conditions of the printer 102 include a method that counts the total number of print pages on a division-by-division basis. According to this method, a user name (division name) and a password of each division are input before the start of printing, and then printing is started. On this occasion, which division is to perform printing can be ascertained based on the input division name and password, and hence the number of pages can be counted.

It should be noted that although in the third embodiment, a UI screen equivalent to the login screen 500 in FIG. 5A is used as a login screen of the RUI 401, one on which only an input field for a “division name” corresponding to a user name and a “password” and a “log-in button” are displayed is used. Namely, at the time of login, the user does not have to select whether he or she is to log in as an administrator or a general user but has to input a “division name” and a “password” and depress the “login button”.

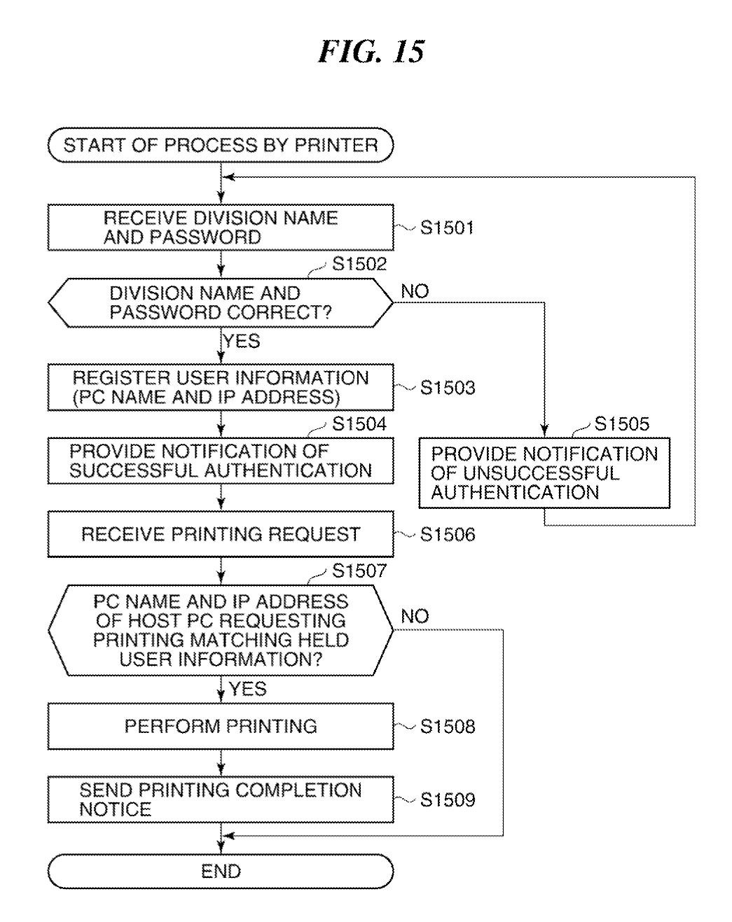

FIG. 15 is a flowchart showing a variation of a process carried out by the printer 102. The CPU 301 of the printer 102 receives a division name and a password input on the RUI 401 by the user 104 and also receives a PC name and an IP address of a source host PC 101 (step S1501). The CPU 301 performs authentication of the division name and the password, that is, carries out a process in which it collates the received division name and password with setting information (step S1502). When authentication is successful (YES in the step S1502), the CPU 301 registers the received PC name and IP address as the user information 403 (step S1503) and notifies the RUI 401 that authentication is successful (step S1504). On the other hand, when authentication is not successful (NO in the step S1502), the CPU 301 notifies the RUI 401 that authentication is not successful (step S1505) and returns to the step S1501, in which it waits for a division name and a password to be resent.

Then, the CPU 301 receives a printing request (step S1506). It should be noted that the printing request is issued by, for example, selecting a “print” command by various applications operating on the host PC 101. The CPU 301 compares the held user information 403 with the information (the PC name and the IP address) on the host PC 101 that has issued the printing request (step S1507).

When the user information 403 and the information on the host PC 101 do not mach each other (NO in the step S1507), the process is terminated without printing being performed. In this case, a message saying that printing will not be executed may be displayed. When the user information 403 and the information on the host PC 101 mach each other (YES in the step S1507), the CPU 301 performs printing and counts the number of pages (step S1508). After that, the CPU 301 notifies the host PC 101 that printing has been completed (step S1509) and terminates the process. Thus, to perform printing a plurality of times from the host PC 101 which a user has logged in on the RUI 401, there is no need to enter a division name and a password for the purpose of division-by-division management each time printing is performed, and hence, convenience for users can be enhanced.

In the first embodiment, after a user logs in as an administrator on the RUI 401, the printer 102 holds the user information 403, and the status window 402 determines whether or not it is possible to perform a job operation. On the other hand, after a user logs in as an administrator on the RUI 401, informant on the administrator may be held on the host PC 101, and the status window 402 may refer to the information to determine whether or not it is possible to perform a job operation. Moreover, although in the third embodiment, a division name and a password are entered on the RUI 401, the number of pages can be counted with respect to each division by performing authentication through only a password.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-038531 filed Feb. 24, 2012, which is hereby incorporated by reference herein in its entirety.

What is claimed is:

1. A system, comprising:
an image forming apparatus; and
at least one image processing apparatus configured to be connected to said image forming apparatus and in which a first application and a second application that can issue an operating instruction to said image forming apparatus are installed,
wherein said image forming apparatus comprises a holding unit that holds information on an image processing apparatus which has been shifted to a mode in which the first application can carry out a predetermined operation to said image forming apparatus among said at least one image processing apparatus while the image processing apparatus is shifted to the mode, and
wherein said at least one image processing apparatus comprises a first obtaining unit that obtains information as to whether a process corresponding to a predetermined operation instruction is disabled in said image forming apparatus, a second obtaining unit that obtains, in a case where the first obtaining unit obtains the information indicative of execution of the process corresponding to the predetermined operation instruction being disabled when the second application issues the predetermined operation instruction to said image forming apparatus, the information on said image processing apparatus which is held by the holding unit of said image forming apparatus, and a control unit that determines whether the predetermined operation instruction to said image forming apparatus by the second application is enabled based on the information obtained by the second obtaining unit.

2. A system according to claim 1, wherein the control unit enables the predetermined operation instruction to said image forming apparatus by the second application when the information obtained by the second obtaining unit indicates an image processing apparatus on which the second application is running, and disables the predetermined operation instruction to said image forming apparatus by the second application when the information obtained by the second obtaining unit do not indicate the image processing apparatus on which the second application is running.

3. A system according to claim 2, wherein the control unit causes a screen corresponding to the second application to display an instruction screen for starting up the first application when the predetermined operation instruction to said image forming apparatus by the second application is disabled.

4. A control method for a system comprising an image forming apparatus and at least one image processing apparatus configured to be connected to the image forming apparatus and in which a first application and a second application that can issue an operating instruction to the image forming apparatus are installed, the method comprising:
a holding step of holding in the image forming apparatus information on an image processing apparatus which has been shifted to a mode in which the first application can carry out a predetermined operation to the image forming apparatus among the at least one image processing apparatus while the image processing apparatus is shifted to the mode, and
a first obtaining step of obtaining information as to whether a process corresponding to a predetermined operation instruction by the second application is disabled in the image forming apparatus,
a second obtaining step of, in a case where the information indicative of execution of the process corresponding to the predetermined operation instruction being disabled is obtained in said first obtaining step when the second application issues the predetermined operation instruction to the image forming apparatus, obtaining the information held in the image forming apparatus in said holding step, and
a control step of determining whether the predetermined operation instruction to the image forming apparatus by the second application is enabled based on the information obtained in said second obtaining step.

5. An image processing apparatus that is connected to an image forming apparatus and in which a first application and a second application that can issue an operating instruction to the image forming apparatus are installed, comprising:
an obtaining unit configured to obtain from the image forming apparatus information as to whether a process corresponding to a predetermined operation instruction is disabled in the image forming apparatus, and
a control unit configured to, in a case where said obtaining unit has been obtained the information indicating that the process corresponding to the predetermined operation instruction is disabled, enables the predetermined operation instruction to the image forming apparatus by the second application when the first application is in a mode in which the first application can carry out a predetermined operation to the image forming apparatus, and disables the predetermined operation instruction to the image forming apparatus by the second application when the first application is not in the mode.
